(19) United States
(12) Patent Application Publication
(10) Pub. No.: US 2007/0025304 A1
(43) Pub. Date: Feb. 1, 2007

(54) System and method for prioritizing transmission legs for precaching data

(76) Inventors: Rangsan Leelahakriengkrai, Streamwood, IL (US); John M. Harris, Chicago, IL (US); Ivan N. Vukovic, Arlington Heights, IL (US); Fan Wang, Vernon Hills, IL (US)

Correspondence Address: MOTOROLA, INC., 1303 EAST ALGONQUIN ROAD, IL01/3RD, SCHAUMBURG, IL, 60196, US

(21) Appl. No.: 11/189,468

(22) Filed: Jul. 26, 2005

(51) Int. Cl. H04Q 7/20; H04Q 7/24; H04B 7/216; H04Q 7/00

(52) U.S. Cl. 370/338; 370/328; 455/452.2

(57) ABSTRACT

At least one transmission condition associated with making a transmission of pre-cache data over a transmission leg (112 or 114) of a network is obtained. A priority for transmitting the pre-cache data is determined using the transmission condition.

### FIELD OF THE INVENTION

The field of the invention relates to routing communications through networks and, more specifically, to prioritizing traffic within these systems.

### BACKGROUND OF THE INVENTION

Data is transmitted between different entities in communication networks. For instance, data may be transmitted from a Base Station Controller (BSC) to a Base Transceiver Site (BTS) and from the BTS to a mobile station. Each BTS has an associated coverage area and the mobile stations may move between coverage areas of different BTSs.

As data is transmitted across the network, it may also be stored at various locations for different purposes. For instance, data may be pre-cached at buffers at a BTS in order to be ready for use by a mobile station when the mobile station can utilize the data. When the mobile station is ready, the data is downloaded to the mobile station.

As mentioned, mobile stations often move between coverage areas of different BTSs. When pre-caching is being used, data that had been pre-cached needs to be forwarded to the new BTS associated with the mobile station. If large amounts of data are involved, some data may not reach the new BTS due to the reselection process.

Some previous systems attempted to solve these problems by employing data flooding techniques. In data flooding, a BSC sent a multicast transmission of the stored data to all potential BTSs in order to ensure reaching the mobile station. Although data flooding allowed the data to reach the mobile station, the use of flooding consumed valuable transmission bandwidth and usually took a long time to accomplish. Consequently, network resources often became overloaded causing delays and inconvenience to users.

In other previous approaches, data was pre-cached only after site reselection had occurred. While this approach avoided overloading the system's bandwidth, it delays the data downloading since the mobile station had to wait for the reselection to be completed before pre-caching could be used. This reduces the potential data download rate the mobile station can achieve.

### BRIEF DESCRIPTION OF THE DRAWINGS

FIG. 1 is a block diagram of a system for prioritizing the transmission of data along transmission legs of a network according to the present invention;

FIG. 2 is a flow chart illustrating one example of an approach for prioritizing the transmission legs of pre-cache data according to the present invention;

FIG. 3 is a block diagram for of a device that prioritizes data along transmission legs of a network according to the present invention;

FIG. 4 is a call-flow diagram of an approach for prioritizing the transmission of data along transmission legs of a network according to the present invention; and

FIG. 5 is a flow chart illustrating one example of determining a priority of pre-cache data according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method is used to prioritize the transmission of pre-cache data along the transmission legs in a network. By prioritizing the transmission of the data, the system is not overloaded by the data transmissions and data can be pre-cached and used even as mobile stations move between different Base Transceiver Stations (BTSs).

In many of these embodiments, at least one transmission condition associated with making a transmission of pre-cache data over a transmission leg of a network is obtained. A priority for transmitting the pre-cache data is then determined using the transmission condition. Other types of priority information can be determined.

The determined priority, in one approach, identifies which packets are to be pre-cached and to which BTSs these packets are to be eventually sent. In another approach, the priority defines a schedule for sending the pre-cache data to the BTS and an amount of packets to be transmitted.

Different parameters may be used to determine the priority. For instance, transmission information that is related to a condition of the transmission leg may be received and used to determine the priority. This transmission information may include the amount of backhaul loading on the transmission leg, the time of day, the Radio Frequency (RF) delay on the transmission leg in combination with the time of day, whether the transmission leg is a candidate for a group call, whether the signal strength is lower in the transmission leg as compared to another transmission leg, indications that a packet is of a high priority and has not been downloaded to a site, the amount of backhaul loading at a given time, the amount of Radio Frequency (RF) loading at a given time, the amount of Radio Access Network (RAN) loading at a given time, the buffer level on a transmission leg and the buffer level at a playout buffer at a mobile station, the length of a cell reselection time on a transmission leg, whether extra buffer space exists, whether the transmission leg has a different associated base station controller as compared to the primary transmission leg, or the number of mobiles connected to the transmission leg.

In others of these embodiments, transmission information is received that is related to a condition of a mobile station and this is used to set a priority. This type of information may include the battery life of the mobile station, the location of the mobile station, the velocity of the mobile station, the direction of movement of the mobile station, the number of transmission legs with which the mobile station has established a connection, the volume of traffic at the mobile station, an indication that the time stayed on the transmission leg by the mobile station is high, the promotional plan used at the mobile station, whether the mobile station belongs to a high-priority group, the identity of a preferred application being run by the mobile station, or whether the mobile station is an 802.11 compatible access point (or compatible to a similar protocol).

In still others of these embodiments, transmission information is received that is related to a condition of a call and this is used to establish the priority. For instance, this information may include whether the call is an emergency call, the security level associated with the call, the identity of a premium application associated with a call, the identity of a streaming application, the identity of a delay-sensitive application, the identity of a file transmission over a primary transmission leg that is near the end of a file, the identity of a file transmission over a primary transmission leg that experiences excessive delay and times out, information indicating the received data rate is below a threshold, or whether the call is undergoing a handoff between different types of equipment.

In yet other embodiments, the transmission condition is related to a condition of the user and this is used to set the priority. For example, this information may include whether the user is a premium user, the type of billing plan associated with the user, the type of equipment utilized by the user, or the frequency of network use by the user.

Other conditions may also be used to determine priority and other actions may be taken. For instance, in some of these embodiments, data compression may be used to compress the pre-cache data on the transmission leg whenever a low priority for the at least transmission one leg is determined. In still others of these embodiments, it may be determined whether a number of mobile stations are likely to substantially simultaneously initiate a handoff and, responsively, the system may initiate pre-filling. The determination may be based upon information such as the number of previous handoffs that were made at substantially the same time by the number of mobile stations, information indicating the number of mobile stations are on a same conveyance, and information indicating that a traffic signal has changed which will result in a correlated handoff event.

Thus, a system and method are described that prioritize data for transmission along the transmission legs in a network. Conveniently, particular packets and transmission legs can be selected and a transmission schedule determined based upon a variety of transmission conditions related to the users, mobile stations, transmission legs, and/or other factors associated with a call. These approaches are efficient, do not overload the resources of the system, and allow pre-caching to be used.

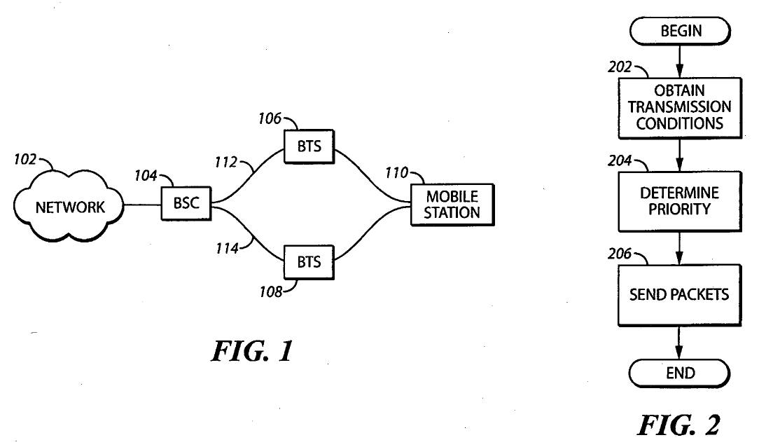

Referring now to FIG. 1, one example of a system for prioritizing the transmission of pre-cache data is described. A network 102 is coupled to a Base Station Controller (BSC) 104. The BSC 104 is coupled to Base Transceiver Stations (BTSs) 106 and 108. The BTSs 106 and 108 may be coupled to a mobile station 110.

Data is sent from the network 102 to be stored at the BSC 104. A first transmission leg 112 exists from the BSC 104 to the BTS 106 and then to the mobile station 110. A second transmission leg 114 exists from the BSC 104 to the BTS 108 and to the mobile station 110. The later portion of either of the transmission legs 112 or 114 may be a radio link between the appropriate BTS 106 and 108 and the mobile station 110. The other portions of the legs 112 or 114 may be wireless, hard-wired, or any other type of communication link.

Information related to the legs, the mobile stations, or from other entities is transmitted to the BSC 104 so that the BSC 104 can determine a priority. The determined priority may identify the packets and/or the BTS 106 or 108 to which to send these packets. The determined priority may also identify an amount of packets to send and/or a schedule to send these packets. Other types of priority information may also be determined.

In one example of the operation of the system of FIG. 1, at least one transmission condition associated with making a transmission of pre-cache data over a transmission leg 112 or 114 of a network is obtained by the BSC 104. A priority for transmitting the pre-cache data is determined by the BSC 104 using the transmission condition.

The BSC 104 may obtain a variety of different transmission conditions in order to determine a priority. For example, transmission information that is related to a condition of one (or both) of the transmission legs 112 or 114 may be used to determine priority. In some examples, this information may be related to a condition of the transmission leg such as the amount of backhaul loading on the transmission leg 112 or 114, the time of day, the Radio Frequency (RF) delay on the transmission leg 112 or 114 and a time of day, whether the transmission leg 112 or 114 is a candidate for a group call, whether a signal strength is lower in the transmission leg 112 or 114 as compared to another transmission leg, an indication that a packet is of a high priority and has not been downloaded to a site, the amount of backhaul loading at a given time, an amount of Radio Frequency (RF) loading at a given time, an amount of Radio Access Network (RAN) loading at a given time, a buffer level on the transmission leg 112 or 114 and a buffer level at a playout buffer at the mobile station 10, the length of a cell reselection time on a transmission leg 112 or 114, whether extra buffer space exists, whether the transmission leg 112 or 114 has a different associated base station controller than a primary leg, or a number of mobile stations connected to the transmission leg.

In one example of the application of these conditions, the time of day is detected to be 11:00 pm. Based upon the time of day, a priority including the transmission leg 114, an amount of data (all pending data), and a schedule (transmit immediately) is determined and the data is transmitted along leg 114 according to this priority. It will be appreciated that other examples of determining this priority and applying this priority to transmit data are possible.

In other examples, transmission information is received that is related to a condition of a mobile station 110 and this is used to determine the priority. This type of information may include the battery life of the mobile station 110, the location of the mobile station 110, the velocity of the mobile station 110, the direction of movement of the mobile station 110, the number of transmission legs with which the mobile station 110 has established a connection, the volume of traffic at the mobile station 110, whether the time stayed on the transmission leg by the mobile station 110 is high, the promotional plan used at the mobile station 110, whether the mobile station 110 belongs to a high-priority group, the identity of a preferred application being run by the mobile station 110, or whether the mobile station is a 802.11 compatible access point (or compatible to a similar protocol).

In one example of the application of these conditions, the battery condition of the mobile station is determined to be low. Based upon this condition, a priority including the transmission leg 114, an amount of data (only some of the pending data), and a schedule (transmit at 12:00 pm midnight) is determined and the data is transmitted along leg 114 according to this priority. Again, it will be appreciated that other examples of determining this priority and applying this priority to transmit data are possible.

In still other examples, transmission information is received that is related to a condition of a call and this is used to determine the priority. For instance, this information may include whether the call is an emergency call, the security level associated with the call, the identity of a premium application associated with a call, the identity of a streaming application, the identity of a delay-sensitive application, the identity of a file transmission over a primary transmission leg that is near the end of a file, the identity of a file transmission over a primary transmission leg that experiences excessive delay and times out, information indicating a received data rate is below a threshold, or whether a call is undergoing a handoff between different types of equipment.

In one example of the application of these conditions, a call is determined to be an emergency call. Based upon the nature of the call (emergency), a priority including the transmission leg 114, an amount of data (all pending data), and a schedule (transmit immediately) is determined and the data is transmitted along leg 114 according to this priority. Once again, it will be appreciated that other examples of determining this priority and applying this priority to transmit data are possible.

In yet other examples, the transmission condition is related to a condition of a user is used to determine the priority. For example, this information may include whether the user is a premium user, the type of bill plan associated with the user, the type of equipment utilized by the user, or the frequency of network use by the user.

In one example of the application of these conditions, it is determined that the user is a premium user. Based upon the identity of the user, a priority including the transmission leg 114, an amount of data (all pending data), and a schedule (transmit immediately) is determined and the data is transmitted along leg 114 according to this priority. Again, it will be appreciated that other examples of determining this priority and applying this priority to transmit data are possible.

Referring now to FIG. 2, one example of an approach for prioritizing the transmission of pre-cache data is described. At step 202, transmission conditions are obtained. For example, these transmission conditions may include conditions related to the condition of the transmission leg, the condition of a user, the condition of a mobile station, or the condition of a call. At step 204, a priority is determined to transmit the data. The determined priority may include the identity of packets within the pre-cache data and the identity of a base station to which to send the packets. In another example, the amount of data to send may be determined. In still another example, a schedule may be obtained. A single condition or combination of conditions obtained at step 202 may be used to make the priority determination.

At step 206, the packets may be sent according to the priority. In one example, a determined amount of packets (determined at step 204) are sent to a BTS (also identified at step 204).

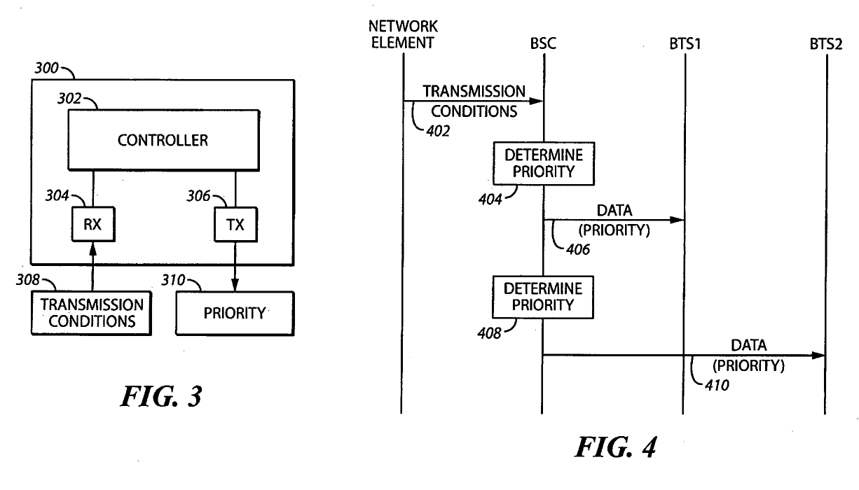

Referring now to FIG. 3, one example of a device 300 for determining the priority by which to transmit pre-cache data is described. The device 300 includes a controller 302, a receiver 304, and a transmitter 306. The controller 302 is coupled to the receiver 304 and the transmitter 306, and is programmed to receive at the input of the receiver 304 a transmission condition or conditions 308 associated with making a transmission of pre-cache data using a transmission leg of a network. As mentioned above, the conditions may be related to the condition of the transmission leg, the condition of a user, the condition of a mobile station, or the condition of a call. Other examples of conditions are possible.

The controller 302 determines a priority 310 for transmitting the pre-cache data using the transmission conditions 308. The determined priority 310 may, for example, include the identity of packets to be sent to a determined base station. The determined priority 310 is based upon a condition or combination of conditions 308 received at the receiver 304.

Referring now to FIG. 4, one example of an approach for prioritizing the transmission of pre-cache data is described. At step 402, transmission conditions are sent from a network element or elements to a BSC. These transmission conditions may include conditions related to a transmission leg, a user, a mobile station, or some other factor.

At step 404, the BSC determines a priority. In determining a priority to transmit the pre-cache data, the BSC may determine an identity of a BTS to send the pre-cache data, an identity of the packets to send to the BTS, an amount of packets to send to the BTS, or a schedule under which to send the pre-cache data to a BTS. Other types of priority information may also be determined.

At step 406, the data (i.e., packets) is sent to a BTS according to the priority. In this case, the BTS has been identified at step 404 as has the amount of packets to be sent.

At a later time, the priority may be re-determined. For example, after the passage of a variable or predetermined amount of time, at step 408, the priority is re-determined based on the same transmission conditions as described above as these conditions have changed over time.

At step 410, the data is sent to a second BTS. In this case, step 408 has determined a new BTS to which to the packets are to be sent as well as a new amount of packets to be sent.

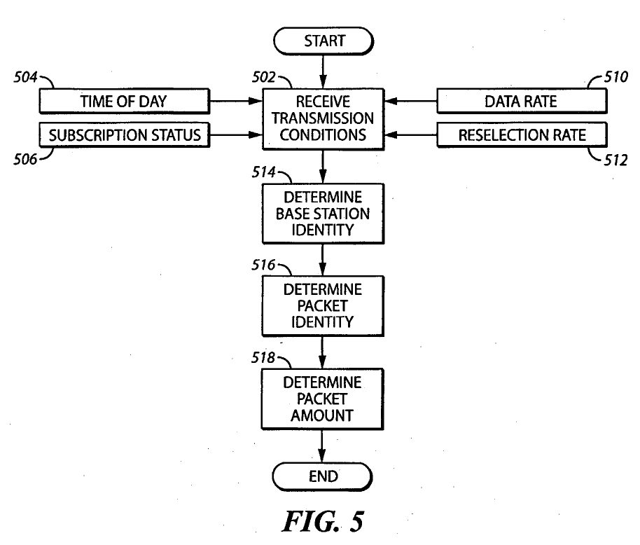

Referring now to FIG. 5, one example of an approach for using a transmission condition to determine a priority is described. In this example, the system includes two transmission legs A and B. At step 502, the system receives transmission conditions that are used to determine a priority. These include the time of day 504, the subscription status of a user 506, the data rate 510 on the “A” transmission leg, and the cell reselection rate 512 on the “B” transmission leg.

At step 514, the system determines the identity of the base station based upon factor 504. At step 516, the system determines the identity of the packets to be sent based upon the factors 506. At step 518, the system determines the total amount of packets to be sent based upon the factors 510 and 512. Those skilled in the art will realize that various algorithms and/or approaches may be used to implement steps 514, 516, and 518. For example, for step 504, if a call is to be made in the afternoon, a first base station may be selected while if the call is to be made in the afternoon, a second base station may be selected.

It will also be understood that the example given with respect to FIG. 5 is only one possible example. Thus, other types of priority information may be determined and different combinations of characteristics may be used to determine the priority information.

Thus, a system and method are given that prioritize data for transmission along transmission legs in a network. Conveniently, particular packets and transmission legs can be selected and the transmission schedule based upon a variety of transmission conditions related to the users, mobile stations, transmission legs, and/or other factors associated with a call. These approaches are efficient and do not overload the resources of the system.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of assigning a priority to a transmission leg in a network comprising:
obtaining at least one transmission condition associated with making a transmission of pre-cache data over a transmission leg of a network; and
determining a priority for transmitting the pre-cache data using the at least one transmission condition.

2. The method of claim 1 wherein determining a priority comprises determining an identity of packets within the pre-cache data and an identity of a base station to which to send the packets.

3. The method of claim 2 further comprising scheduling the sending of the pre-cache data to the base station according to the priority.

4. The method of claim 1 further comprising determining an amount of packets to be transmitted to the base station based upon the priority.

5. The method of claim 4 wherein determining an amount comprises determining an amount that is related to a data rate of the transmission leg and a cell reselection time associated with the transmission leg.

6. The method of claim 1 wherein obtaining the at least one transmission condition comprises receiving transmission information that is related to a condition of the transmission leg.

7. The method of claim 6 wherein receiving the transmission information comprises receiving information related to a condition of the transmission leg, the condition being selected from a group comprising: an amount of backhaul loading on the transmission leg; a time of day; a Radio Frequency (RF) delay on the transmission leg and a time of day; whether the transmission leg is a candidate for a group call; whether a signal strength is lower in the transmission leg as compared to another transmission leg; an indication that a packet is of a high priority and has not been downloaded to a site; an amount of backhaul loading at a given time; an amount of Radio Frequency (RF) loading at a given time; an amount of Radio Access Node (RAN) loading at a given time; a buffer level on a transmission leg and a buffer level at a playout buffer at a mobile station; a length of a cell reselection time on a transmission leg; whether extra buffer space exists; whether the transmission leg has a different associated base station controller than a primary leg; and a number of mobiles connected to the transmission leg.

8. The method of claim 1 wherein obtaining the at least one transmission condition comprises receiving transmission information that is related to a condition of a mobile station.

9. The method of claim 8 wherein receiving transmission information comprises receiving transmission priority information selected from a group comprising: a battery life of the mobile station; a location of the mobile station; a velocity of the mobile station; a direction of movement of the mobile station; a number of transmission legs with which the mobile station has established a connection; a volume of traffic at the mobile station; a time stayed on the transmission leg by the mobile station is high; a promotional plan used at the mobile station; whether the mobile station belongs to a high-priority group; an identity of a preferred application being run by the mobile station; and whether the mobile station is a 802.11 compatible access point.

10. The method of claim 1 wherein obtaining the at least one transmission condition comprises receiving transmission information that is related to a condition of a call.

11. The method of claim 10 wherein receiving the transmission information comprises receiving transmission information associated with a call condition, the condition being selected from a group comprising: whether the call is an emergency call; a security level associated with the call; an identity of a premium application associated with a call; an identity of a streaming application; an identity of a delay-sensitive application; an identity of a file transmission over a primary transmission leg that is near the end of a file; an identity of a file transmission over a primary transmission leg experiences excessive delay and times out; information indicating a received data rate is below a threshold; and whether a call is undergoing a handoff between different types of equipment.

12. The method of claim 1 wherein obtaining the at least one transmission condition comprises receiving transmission information that is related to a condition of a user.

13. The method of claim 12 wherein receiving the transmission information comprises receiving transmission information related to a condition of the user, the condition of the user being selected from a group comprising: whether the user is a premium user; a type of bill plan associated with the user; a type of equipment utilized by the user; and a frequency of network use by the user.

14. The method of claim 1 further comprising applying data compression to the pre-cache data on the transmission leg whenever a low priority for the at least transmission one leg is determined.

15. The method of claim 1 further comprising determining whether a number of mobile stations are likely to substantially simultaneously initiate a handoff and, responsively, to initiate pre-filling.

16. The method of claim 15 wherein the determining comprises determining from received information, the information selected from a group comprising: information indicating previous handoffs were made at substantially the same time by the number of mobile stations; information indicating the number of mobile stations are on a same conveyance; and information indicating that a traffic signal has changed which will result in a correlated handoff event.

17. A device for determining a priority for transmitting data on a transmission leg of a network comprising:
a receiver having an input;
a transmitter having an output; and
a controller coupled to the receiver and the transmitter, the controller programmed to receive at the input of the receiver at least one transmission condition associated with making a transmission of pre-cache data using a transmission leg of a network and to determine a priority for transmitting the pre-cache data using the at least one transmission condition.

18. The device of claim 17 wherein the at least one transmission condition is selected from a group comprising: a condition of the transmission leg; a condition of a user; a condition of a mobile station; and a condition of a call.

19. A system for prioritizing the transmission legs of a network comprising:
at least one base station; and
a base station controller coupled to the at least one base station, the base station controller programmed to obtain at least one transmission condition associated with making a transmission of pre-cache data via a transmission leg in a network and to determine a priority for transmitting the pre-cache data using the at least one transmission condition.

20. The system of claim 19 wherein the base station controller is further programmed to send the pre-cache data to the at least one base station according to the priority.
